(19) United States
(12) Patent Application Publication
(10) Pub. No.: US 2026/0233467 A1
(43) Pub. Date: Aug. 13, 2026

(54) 3D PRINTING WITH IN-PROGRESS MATERIAL COMPATIBILITY EVALUATION

(71) Applicant: INTERNATIONAL BUSINESS MACHINES CORPORATION, Armonk, NY (US)

(72) Inventors: Randy A. Rendahl, Raleigh, NC (US); Sarbajit Kumar Rakshit, Kolkata (IN); Vinod Anandram Valecha, Pune (IN); Tushar Agrawal, West Fargo, ND (US)

(21) Appl. No.: 19/049,334

(22) Filed: Feb. 10, 2025

(51) Int. Cl. B29C 64/393; B29C 64/336; B33Y 40/00; B33Y 50/02; G01N 21/27; B29C 64/118; B33Y 10/00

(52) U.S. Cl. CPC B29C 64/393; B29C 64/336; B33Y 40/00; B33Y 50/02; G01N 21/27; B29C 64/118; B33Y 10/00

(57) ABSTRACT

Methods and systems for three-dimensional (3D) printing include identifying an original material of a piece. A new material is identified that is compatible with the piece, different from the original material, according to a set of properties. The new material is deposited on the original material using an extrusion-type printing process.

### BACKGROUND

The present invention generally relates to additive manufacturing and, more particularly, to three-dimensional (3D) printing with multiple materials.

3D printing, and additive manufacturing generally, is a process of making 3D solid objects based on a digital design. The creation of a 3D printed object is achieved using a process that lays down successive layers of material according to the design. Each layer may be seen as a thinly sliced cross-section of the object. Subtractive manufacturing, meanwhile, removes material from a piece. Types of subtractive manufacturing include drills and mills guided by a computer numerical control (CNC) system.

### SUMMARY

A method for three-dimensional (3D) printing includes identifying an original material of a piece. A new material is identified that is compatible with the piece, different from the original material, according to a set of properties. The new material is deposited on the original material using an extrusion-type printing process.

A computer program product includes one or more computer-readable storage media and program instructions stored on the one or more computer-readable storage media to perform operations. The operations include identifying an original material of a piece, identifying a new material that is compatible with the piece, different from the original material, according to a plurality of properties, and triggering deposition of the new material on the original material using an extrusion-type printing process.

A computer system includes a processor set, one or more computer-readable storage media, and program instructions stored on the one or more computer-readable storage media to cause the processor set to perform operations. The operations include identifying an original material of a piece, identifying a new material that is compatible with the piece, different from the original material, according to a plurality of properties, and triggering deposition of the new material on the original material using an extrusion-type printing process.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a diagram of a three-dimensional (3D) printing system that selects material that is compatible with the material of a preexisting piece, in accordance with an embodiment of the present invention;

FIG. 2 is a block/flow diagram of a method for 3D printing with a material that is compatible with the material of a preexisting piece, in accordance with an embodiment of the present invention;

FIG. 3 is a block/flow diagram of a method for determining a material that is compatible with the material of a preexisting piece, in accordance with an embodiment of the present invention; and

FIG. 4 is a block diagram of a computing environment that can be used to repair a piece by 3D printing with a compatible material, in accordance with an embodiment of the present invention.

### DETAILED DESCRIPTION

An exemplary application of three-dimensional (3D) printing is the fabrication of parts that can be used to repair damage to existing devices and structures. For example, a 3D model of a broken portion of an object can be used to replicate that portion. Integrating the 3D printed part with the broken object may need to ensure bonding between the existing portions and the 3D printed portion. Additionally, the 3D part may be formed with a color that matches the existing object to minimize visual distinctions between the two.

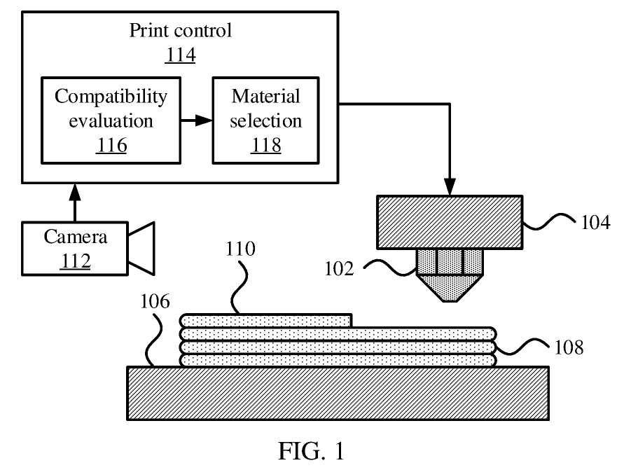

Referring now to FIG. 1, an exemplary 3D printing system is shown. A print head 102 is attached to a gantry 104 or other fixture that moves laterally over a print bed 106. As the print head moves, it extrudes a print material, which is deposited on the print bed 106. After a full layer is deposited, the gantry 104 moves the print head 102 vertically and a next layer is deposited on top of the previous layer. As multiple layers 108 are formed on top of one another, a 3D object is formed in accordance with an input design. In some embodiments, the layers 108 may be formed from polyethylene terephthalate glycol (PETG), a thermoplastic, but it should be understood that other materials may be used instead. This view of a 3D printing system is intended to be purely exemplary and should not be regarded as limiting—other types of 3D printing are contemplated and fall within the scope of the present principles.

In some cases, a previously printed object may be broken or damaged in some way. For example, an impact may cause printed layers to separate, so that one or more layers are missing. In some cases, errors during fabrication (e.g., a cohesion failure) may cause damage to the object. In such cases, the damage may be repaired by depositing additional material onto the previous layers 108, integrating with any damaged layers 110.

During the repair printing process, cameras 112 may monitor the print-in-progress. There may be multiple cameras 112 that view the repair-in-progress from different angles. The images from the cameras 112 are sent to a print control 114 which controls the gantry 104 and the print head 102. Compatibility evaluation is performed to ensure that the material which is being used to perform the repair bonds well with the previous layers 108 and the damaged layers 110, and may further ensure that a color of the new deposition matches the previous layers 108 to minimize visual discrepancies.

The 3D printing system may use any appropriate extrusion-type 3D printing process, such as fused filament fabrication. Exemplary materials include thermoplastics, composite filaments, high-performance polymers, ceramic-based filaments, and specialty materials. Examples of thermoplastics include polylactic acid, acrylonitrile butadiene styrene, polyethylene terephthalate glycol, nylon, and thermoplastic polyurethan or thermoplastic elastomers. Composite filaments combine a thermoplastic with another material, such as wood fibers, carbon fiber, and metal powders. High-performance polymers include materials such as polyether ether ketone, polyetherimide, and polyphenylsufone. Specialty materials include materials having certain purpose-specific properties, such as dissolvable filaments, conductive filaments, magnetic filaments, food-safe materials, and biodegradable materials.

Each material will have its own respective bonding properties, such that certain materials will be more appropriate for bonding to the material of an existing structure than others. The materials will furthermore have different respective fabrication properties, for example a temperature that is needed to extrude the material from the print head 102. In some cases the temperature needed to extrude the material may exceed a melting or smoke point of the existing structure.

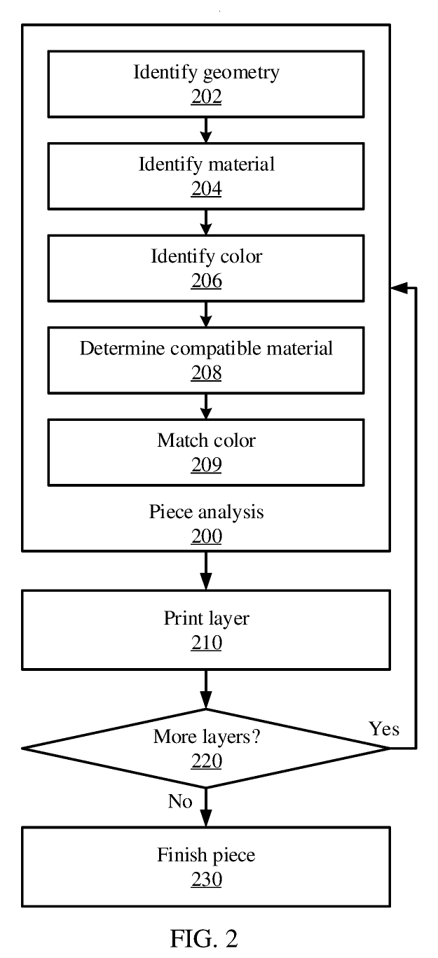

Referring now to FIG. 2, a method of repairing a broken piece is shown. Block 200 performs piece analysis to select a material and color that will bond well with the broken piece and that will minimize visual discrepancies. Block 210 prints a layer of the repair onto the broken piece, bonding the new material with the material of the broken piece. Block 220 determines whether more layers are needed. If so, processing returns to block 200 to perform further analysis before printing the next layer in block 210. If not, block 230 finishes the piece, for example by releasing the piece from the printing system and performing any finishing steps, such as sanding.

The analysis of the piece in block 200 may include multiple steps. Block 202 identifies the geometry of the broken piece, for example using cameras or a 3D scanner. For example, the identification of the geometry may be used to locate a flaw, such as a chip in a ceramic vase. The scan may be performed in multiple steps, for example with a quick, low-resolution scan being performed to locate the defect and with a higher-resolution scan being performed to map the precise contours of the defect. In some cases the identification of the geometry of the broken piece may include a comparison to a geometry of a similar, unbroken piece. For example, a 3D scan or design of the unbroken piece may be available, so that differences between the broken piece and the unbroken piece may be identified as defects.

Block 204 identifies the material of the broken piece. In some cases the material may be identified visually, while in other cases the material may be identified using, e.g., spectroscopic techniques. In some examples a sample of the material may be taken from the broken piece and identified chemically. Block 206 may further identify a color of the exposed material of the broken piece.

Block 208 determines a material that is compatible with the exposed material of the broken piece. Weights may be assigned to properties of the materials based on relevance. Different available materials may then be evaluated for their compatibility, for example according to bonding strength with the material of the broken piece. Another parameter that may be used to determine compatibility is temperature, where a deposition temperature of the new material should not be so high that it causes further damage to the broken piece. Any appropriate classifier may be used to determine compatibility, such as a random forest model.

In some cases, the determination of a compatible material may be performed using a machine learning model that is trained using data relating to the properties of a variety of printable materials. The training process may make use of an error function defined by how far a prediction of the model is from an expected output. As the model is trained, particular material properties may be identified as being more relevant to the outcome than others.

In some cases, different 3D printers may only have certain materials available. If none of the available materials of a given 3D printer system is compatible with the broken piece, then a different 3D printing system, having a compatible material available, may be used instead.

Block 209 may further match the color of the new material with the identified color of the broken piece. In some cases this may include a selection of an existing colored material, such as a plastic filament. In some cases the color of the new material may be mixed to precisely match the color of the broken piece. In some cases multiple materials, having different initial colors, may be mixed during deposition to create a target color using, e.g., CMYK color blending.

During printing 210, the selected material is deposited in a layer directly on the broken piece and/or on a previously deposited layer. At each layer, the analysis 200 may indicate that a different material or color is needed, and so the material may be changed from one layer to the next. In some cases the material and/or color may be changed within a single layer, for example to match an irregularly colored piece.

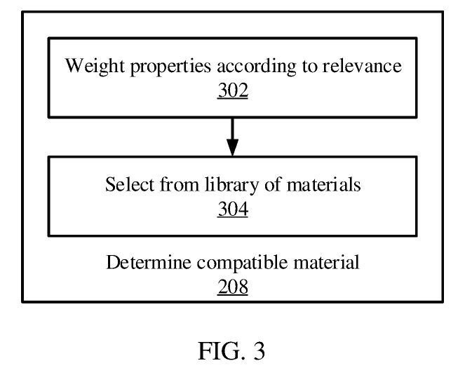

Referring now to FIG. 3, additional detail on the determination of compatible material 208 is shown. After the material is identified by block 204, block 302 weights properties according to their relevance. For example, bonding strength and temperature compatibilities may be weighted in accordance with the needs of the application. In some cases, color may be weighted as a property, as certain materials may only be available in certain colors. Thus for example, having a material that can be deposited at a temperature which does not damage the option may be a more important property than having an exact color match.

Block 304 selects from a library of materials according to the weighted properties. In some cases this may be implemented using a trained random forest model, whereby block 304 navigates a decision tree to identify the best material. The decision tree may include decision nodes that, for example, compare a given property to a threshold, until the library of materials is narrowed down to one or more compliant materials. In some cases the compliant materials may be scored according to the weighted properties, with a highest scoring material being selected.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code involved in performing the inventive methods, such as repair with compatible material 419. In addition to block 200, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 200, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

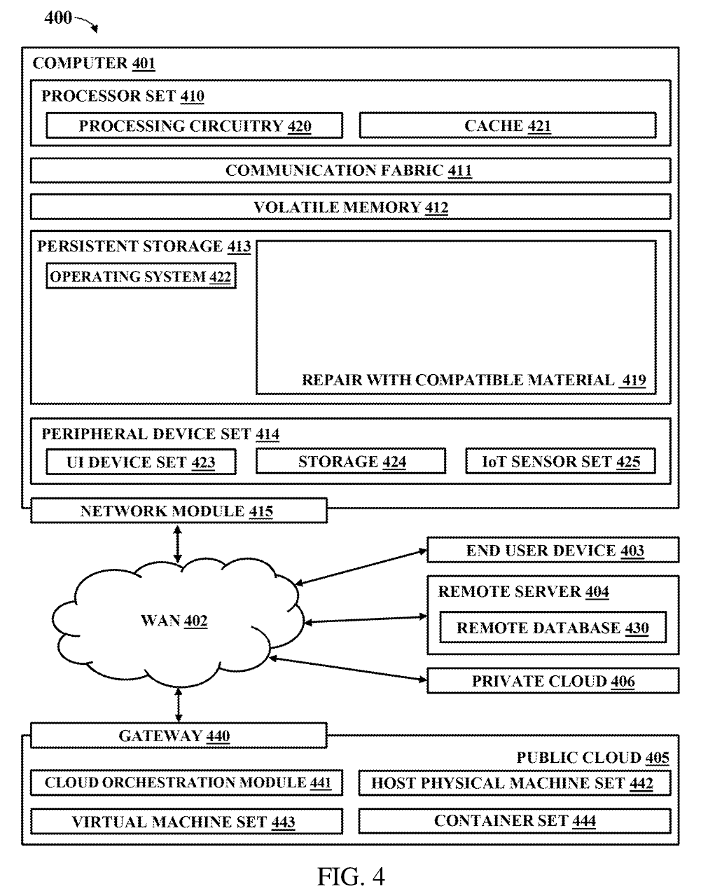

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 200 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415. WAN 402 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method for three-dimensional (3D) printing, comprising:
identifying an original material of a piece;
identifying a new material that is compatible with the piece, different from the original material, according to a plurality of properties; and
depositing the new material on the original material using an extrusion-type printing process.

2. The method of claim 1, further comprising scanning the piece to identify a defect, wherein identifying the original material includes identifying a composition of an exposed surface of the defect.

3. The method of claim 2, wherein scanning the piece includes determining a geometry and wherein depositing the new material on the original material includes depositing the new material in accordance with the geometry to repair the defect.

4. The method of claim 2, further comprising comparing a scan of the piece to a 3D representation of an unbroken piece to identify defects according to differences between the two.

5. The method of claim 1, wherein identifying the new material includes selecting the new material from a material library using a random forest model.

6. The method of claim 4, wherein identifying the new material includes weighting the plurality of properties according to relevance.

7. The method of claim 1, wherein the plurality of properties include at least one property selected from the group consisting of temperature limits, bonding strength, and color.

8. The method of claim 1, further comprising identifying a color of the original material, wherein identifying the new material includes matching the color.

9. The method of claim 7, wherein depositing the new material includes blending a plurality of inputs to match the color.

10. The method of claim 8, wherein identifying the color includes capturing an image of the piece using a camera.

11. A computer program product, comprising:
one or more computer-readable storage media; and
program instructions stored on the one or more computer-readable storage media to perform operations comprising:
identifying an original material of a piece;
identifying a new material that is compatible with the piece, different from the original material, according to a plurality of properties; and
triggering deposition of the new material on the original material using an extrusion-type printing process.

12. A computer system, comprising:
a processor set;
one or more computer-readable storage media; and
program instructions stored on the one or more computer-readable storage media to cause the processor set to perform operations comprising:
identifying an original material of a piece;
identifying a new material that is compatible with the piece, different from the original material, according to a plurality of properties; and
triggering deposition of the new material on the original material using an extrusion-type printing process.

13. The system of claim 12, further comprising scanning the piece to identify a defect, wherein identifying the original material includes identifying a composition of an exposed surface of the defect.

14. The system of claim 13, wherein scanning the piece includes determining a geometry and wherein depositing the new material on the original material includes depositing the new material in accordance with the geometry to repair the defect.

15. The system of claim 13, further comprising comparing a scan of the piece to a 3D representation of an unbroken piece to identify defects according to differences between the two.

16. The system of claim 12, wherein identifying the new material includes selecting the new material from a material library using a random forest model.

17. The system of claim 16, wherein identifying the new material includes weighting the plurality of properties according to relevance.

18. The system of claim 13, wherein the plurality of properties include at least one property selected from the group consisting of temperature limits, bonding strength, and color.

19. The system of claim 13, further comprising identifying a color of the original material, wherein identifying the new material includes matching the color.

20. The system of claim 19, wherein depositing the new material includes blending a plurality of inputs to match the color.
